(19) United States
(12) Patent Application Publication
(10) Pub. No.: US 2006/0256854 A1
(43) Pub. Date: Nov. 16, 2006

(54) Parallel execution of media encoding using multi-threaded single instruction multiple data processing

(76) Inventor: Hong Jiang, San Jose, CA (US)

Correspondence Address: KACVINSKY LLC;C/O INTELLEVATES, P.O. BOX 52050, MINNEAPOLIS, MN, 55402, US

(21) Appl. No.: 11/131,158

(22) Filed: May 16, 2005

(51) Int. Cl. H04N 11/04

(52) U.S. Cl. 375/240.03

(57) ABSTRACT

An apparatus, system, method, and article for parallel execution of media encoding using single instruction multiple data processing are described. The apparatus may include a media processing node to perform single instruction multiple data processing of macroblock data. The macroblock data may include coefficients for multiple blocks of a macroblock. The media processing node may include an encoding module to generate multiple flag words associated with multiple blocks from the macroblock data and to determine run values for multiple blocks in parallel from the flag words. Other embodiments are described and claimed.

### BACKGROUND

Various techniques for encoding media data are described in standards promulgated by organizations such as the Moving Picture Expert Group (MPEG), the International Telecommunications Union (ITU), the International Organization for Standardization (ISO), and the International Electrotechnical Commission (IEC). For example, the MPEG-1, MPEG-2, and MPEG-4 video compression standards describe block encoding techniques in which a picture is divided into slices, macroblocks, and blocks. After performing temporal motion prediction and/or spatial prediction, residue values within a block are entropy encoded. A common example of entropy encoding is variable length encoding (VLC), which involves converting data symbols into variable length codes. More complex examples of entropy coding include context-based adaptive variable length coding (CAVLC) and context-based adaptive binary arithmetic coding (CABAC), which are specified in the MPEG-4 Part 10 or ITU/IEC H.264 video compression standard, Video Coding for Very Low Bit Rate Communication, ITU-T Recommendation H.264 (May 2003).

Video encoders typically perform sequential encoding with a single unit implemented by fixed-function logic or a scalar processor. Due to increasing complexity used in entropy encoding, sequential video encoding consumes a large amount of processor time even with Multi-GHz machines.

### BRIEF DESCRIPTION OF THE DRAWINGS

FIG. 1 illustrates one embodiment of a node.

FIG. 2 illustrates one embodiment of a media processing.

FIG. 3 illustrates one embodiment of a system.

FIG. 4 illustrates one embodiment of a logic flow.

### DETAILED DESCRIPTION

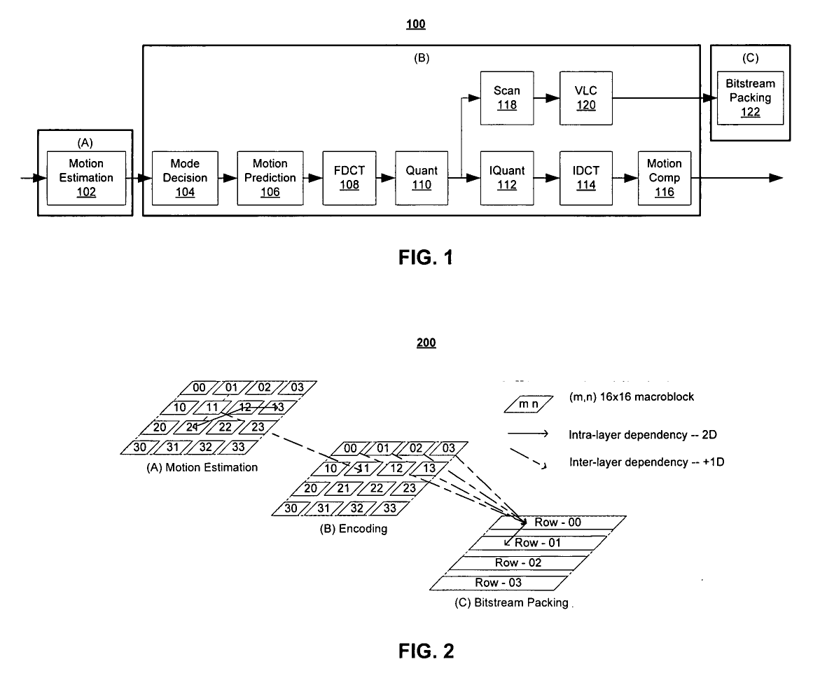

FIG. 1 illustrates one embodiment of a node. FIG. 1 illustrates a block diagram of a media processing node 100. A node generally may comprise any physical or logical entity for communicating information in the system 100 and may be implemented as hardware, software, or any combination thereof, as desired for a given set of design parameters or performance constraints.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station, a radio network controller (RNC), a mobile subscriber center (MSC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

In various embodiments, the media processing node 100 may comprise, or be implemented as, one or more of a processing system, a processing sub-system, a processor, a computer, a device, an encoder, a decoder, a coder/decoder (CODEC), a compression device, a decompression device, a filtering device (e.g., graphic scaling device, deblocking filtering device), a transformation device, an entertainment system, a display, or any other processing architecture. The embodiments are not limited in this context.

In various implementations, the media processing node 100 may be arranged to perform one or more processing operations. Processing operations may generally refer to one or more operations, such as generating, managing, communicating, sending, receiving, storing forwarding, accessing, reading, writing, manipulating, encoding, decoding, compressing, decompressing, reconstructing, encrypting, filtering, streaming or other processing of information. The embodiments are not limited in this context.

In various embodiments, the media processing node 100 may be arranged to process one or more types of information, such as video information. Video information generally may refer to any data derived from or associated with one or more video images. In one embodiment, for example, video information may comprise one or more of video data, video sequences, groups of pictures, pictures, objects, frames, slices, macroblocks, blocks, pixels, and so forth. The values assigned to pixels may comprise real numbers and/or integer numbers. The embodiments are not limited in this context.

In various embodiments, for example, the media processing node 100 may perform media processing operations such as encoding and/or compressing of video data into a file that may be stored or streamed, decoding and/or decompressing of video data from a stored file or media stream, filtering (e.g., graphic scaling, deblocking filtering), video playback, internet-based video applications, teleconferencing applications, and streaming video applications. The embodiments are not limited in this context.

In various implementations, media processing node 100 may communicate, manage, or process information in accordance with one or more protocols. A protocol may comprise a set of predefined rules or instructions for managing communication among nodes. A protocol may be defined by one or more standards as promulgated by a standards organization, such as the ITU, the ISO, the IEC, the MPEG, the Internet Engineering Task Force (IETF), the Institute of Electrical and Electronics Engineers (IEEE), and so forth. For example, the described embodiments may be arranged to operate in accordance with standards for video processing, such as the MPEG-1, MPEG-2, MPEG-4, and H.264 standards. The embodiments are not limited in this context.

In various embodiments, the media processing node 100 may comprise multiple modules. The modules may comprise, or be implemented as, one or more systems, sub-systems, processors, devices, machines, tools, components, circuits, registers, applications, programs, subroutines, or any combination thereof, as desired for a given set of design or performance constraints. In various embodiments, the modules may be connected by one or more communications media. Communications media generally may comprise any medium capable of carrying information signals. For example, communication media may comprise wired communication media, wireless communication media, or a combination of both, as desired for a given implementation. The embodiments are not limited in this context.

The media processing node 100 may comprise a motion estimation module 102. In various embodiments, the motion estimation module 102 may be arranged to receive input video data. In various implementations, a frame of input video data may comprise one or more slices, macroblocks and blocks. A slice may comprise an I-slice, P-slice, or B-slice, for example, and may include several macroblocks. Each macroblock may comprise several blocks such as luminous blocks and/or chrominous blocks, for example. In one embodiment, a macroblock may comprise an area of 16×16 pixels, and a block may comprise an area of 8×8 pixels. In other embodiments, a macroblock may be partitioned into various block sizes such as 16×16, 16×8, 8×16, 8×8, 8×4, 4×8, and 4×4, for example. It is to be understood that while reference may be made to macroblocks and blocks, the described embodiments and implementations may be applicable to other partitioning of video data. The embodiments are not limited in this context.

In various embodiments, the motion estimation module 102 may be arranged to perform motion estimation on one or more macroblocks. The motion estimation module 102 may estimate the content of current blocks within a macroblock based on one or more reference frames. In various implementations, the motion estimation module 102 may compare one or more macroblocks in a current frame with surrounding areas in a reference frame to determine matching areas. In some embodiments, the motion estimation module 102 may use multiple reference frames (e.g., past, previous, future) for performing motion estimation. In some implementations, the motion estimation module 102 may estimate the movement of matching areas between one or more reference frames to a current frame using motion vectors, for example. The embodiments are not limited in this context.

The media processing node 100 may comprise a mode decision module 104. In various embodiments, the mode decision module 104 may be arranged to determine a coding mode for one or more macroblocks. The coding mode may comprise a prediction coding mode, such as intra code prediction and/or inter code prediction, for example. Intra-frame block prediction may involve estimating pixel values from the same frame using previously decoded pixels. Inter-frame block prediction may involve estimating pixel values from consecutive frames in a sequence. The embodiments are not limited in this context.

The media processing node 100 may comprise a motion prediction module 106. In various embodiments, the motion prediction module 106 may be arranged to perform temporal motion prediction and/or spatial prediction to predict the content of a block. The motion prediction module 106 may be arranged to use prediction techniques such as intra-frame prediction and/or inter-frame prediction, for example. In various implementations, the motion prediction module 106 may support bi-directional prediction. In some embodiments, the motion prediction module 106 may perform motion vector prediction based on motion vectors in surrounding blocks. The embodiments are not limited in this context.

In various embodiments, the motion prediction module 106 may be arranged to provide a residue based on the differences between a current frame and one or more reference frames. The residue may comprise the difference between the predicted and actual content (e.g., pixels, motion vectors) of a block, for example. The embodiments are not limited in this context.

The media processing node 100 may comprise a transform module 108, such as forward discrete cosine transform (FDCT) module. In various embodiments, the transform module 108 may be arranged to provide a frequency description of the residue. In various implementations, the transform module 108 may transform the residue into the frequency domain and generate a matrix of frequency coefficients. For example, a 16×16 macroblock may be transformed into a 16×16 matrix of frequency coefficients, and an 8×8 block may be transformed into a matrix of 8×8 frequency coefficients. In some embodiments, the transform module 108 may use an 8×8 pixel based transform and/or a 4×4 pixel based transform. The embodiments are not limited in this context.

The media processing node 100 may comprise a quantizer module 110. In various embodiments, the quantizer module 110 may be arranged to quantize transformed coefficients and output residue coefficients. In various implementations, the quantizer module 110 may output residue coefficients comprising relatively few nonzero-value coefficients. The quantizer module 110 may facilitate coding by driving many of the transformed frequency coefficients to zero. For example, the quantizer module 110 may divide the frequency coefficients by a quantization factor or quantization matrix driving small coefficients (e.g., high frequency coefficients) to zero. The embodiments are not limited in this context.

The media processing node 100 may comprise an inverse quantizer module 112 and an inverse transform module 114. In various embodiments, the inverse quantizer module 112 may be arranged to receive quantized transformed coefficients and perform inverse quantization to generate transformed coefficients, such as DCT coefficients. The inverse transform module 114 may be arranged to receive transformed coefficients, such as DCT coefficients, and perform an inverse transform to generate pixel data. In various implementations, inverse quantization and the inverse transform may be used to predict loss experienced during quantization. The embodiments are not limited in this context.

The media processing node 100 may comprise a motion compensation module 116. In various embodiments, the motion compensation module 116 may receive the output of the inverse transform module 114 and perform motion compensation for one or more macroblocks. In various implementations, the motion compensation module 116 may be arranged to compensate for the movement of matching areas between a current frame and one or more reference frames. The embodiments are not limited in this context.

The media processing node 100 may comprise a scanning module 118. In various embodiments, the scanning module 118 may be arranged to receive transformed quantized residue coefficients from the quantizer module 110 and perform a scanning operation. In various implementations, the scanning module 118 may scan the residue coefficients according to a scanning order, such as a zig-zag scanning order, to generate a sequence of transformed quantized residue coefficients. The embodiments are not limited in this context.

The media processing node 100 may comprise an entropy encoding module 120, such as VLC module. In various embodiments, the entropy encoding module 120 may be arranged to perform entropy coding such as VLC (e.g., run-level VLC), CAVLC, CABAC, and so forth. In general, CAVLC and CABAC are more complex than VLC. For example, CAVLC may encode a value with using an integer number of bits, and CABAC may use arithmetic coding and encode values using a fractional number of bits. The embodiments are not limited in this context.

In various embodiments, the entropy encoding module 120 may be arranged to perform VLC operations, such as run-level VLC using Huffman tables. In such embodiments, a sequence of scanned transformed quantized coefficients may be represented as a sequence of run-level symbols. Each run-level symbol may comprise a run-level pair, where level is the value of a nonzero-value coefficient, and run is the number of zero-value coefficients preceding the nonzero-value coefficient. For example, a portion of an original sequence X₁, X₂, X₃, 0, 0, 0, 0, 0, X₄ may be represented as run-level symbols (0,X₁)(0,X₂)(0,X₃)(5,X₄). In various implementations, the entropy encoding module 120 may be arranged to convert each run-level symbol into a bit sequence of different length according to a set of predetermined Huffman tables. The embodiments are not limited in this context.

The media processing node 100 may comprise a bitstream packing module 122. In various embodiments, the bitstream packing module 122 may be arranged to pack an entropy encoded bit sequence for a block according to a scanning order to form the VLC sequence for a block. The bitstream packing module 122 may pack the bit sequences of multiple blocks according to a block order to form the code sequence for a macroblock, and so on. In various implementations, the bit sequence for a symbol may be uniquely determined such that reversion of the packing process may be used to enable unique decoding of blocks and macroblocks. The embodiments are not limited in this context.

In various embodiments, the media processing node 100 may implement a multi-stage function pipe. As shown in FIG. 1, for example, the media processing node 100 may implement a function pipe partitioned into motion estimation operations in stage A, encoding operations in stage B, and bitstream packing operations in stage C. In some implementations, the encoding operations in stage B may be further partitioned. In various embodiments, the media processing node 100 may implement function- and data-domain-based partitioning to achieve parallelism that can be exploited for multi-threaded computer architecture. The embodiments are not limited in this context.

In various implementations, separate threads may perform the motion estimation stage, the encode stage, and the pack bitstream stage. Each thread may comprise a portion of a computer program that may be executed independently of and in parallel with other threads. In various embodiments, thread synchronization may be implemented using a mutual exclusion object (mutex) and/or semaphores. Thread communication may be implemented by memory and/or direct register access. The embodiments are not limited in this context.

In various embodiments, the media processing node 100 may perform parallel multi-threaded operations. For example, three separate threads may perform motion estimation operations in stage A, encoding operations in stage B, and bitstream packing operations in stage C in parallel. In various implementations, multiple threads may operate on stage A in parallel with multiple threads operating on stage B in parallel with multiple threads operating on stage C. The embodiments are not limited in this context.

In various implementations, the function pipe may be partitioned such that the bitstream packing operations in stage C is separated from the motion estimation operations in stage A and the encoding operations in stage B. The partitioning of the function pipe may be based function- and data-domain-based to achieve thread-level parallelism. For example, the motion estimation stage A and encoding stage B may be data-domain partitioned into macroblocks, and the bitstream packing stage C may be partitioned into rows allowing more parallelism with the computations of other stages. In various embodiments, the final bit sequence packing for macroblocks or blocks may be separated from the bit sequence packing for run-level symbols within a macroblocks or blocks so that the entropy encoding (e.g., VLC) operations on different macroblocks and blocks can be performed in parallel by different threads. By moving the final sequential operation of packing bitstream outside of the macroblock-based encoding operation, sequential dependency may be lessened and parallelism may be increased. The embodiments are not limited in this context.

FIG. 2 illustrates one embodiment of media processing. FIG. 2 illustrates one embodiment of a parallel multi-threaded processing that may be performed by a media processing node, such as media processing node 100. In various embodiments, parallel multi-threaded operations may be performed on macroblocks, blocks, and rows. In the example shown in FIG. 2, for example each macroblock (m,n) may comprise a 16×16 macroblock. For a standard resolution (SD) frame with 720 pixel by 480 lines, M=45, N=30. The embodiments are not limited in this context.

In one embodiment, encoding operations on one or more of macroblocks (10), (11), (12), and (13) in stage B may be performed in parallel with bitstream packing operations performed on Row-00 in stage C. In various implementations, block-level processing may be performed in parallel with macroblock-level processing. Within stage B, for example, block-level encoding operations may be performed within macroblock (10) in parallel with macroblock-level encoding operations performed on macroblocks (00), (01), (02), and (03). The embodiments are not limited in this context.

In various embodiments, parallel multi-threaded operations may be subject to intra-layer and/or inter-layer data dependencies. In the example shown in FIG. 2, intra-layer data dependencies are illustrated by solid arrows, and inter-layer data dependencies are illustrated by broken arrows. In this example, there may be intra-layer data dependency among macroblocks (12), (13) and (21) when performing motion estimation operations in stage A. There also may be inter-layer dependency for macroblock (11) between stage A and stage B. As a result, encoding operations performed on macroblock (11) in stage B may not start until motion estimation operations performed on macroblock (11) in stage A are complete. There also may be inter-layer dependency for macroblocks (00), (01), (02), and (03) between stage B and stage C. As a result, bitstream packing operations on Row-00 in stage C may not start until operations on macroblocks (00), (01), (02), and (03) are complete. The embodiments are not limited in this context.

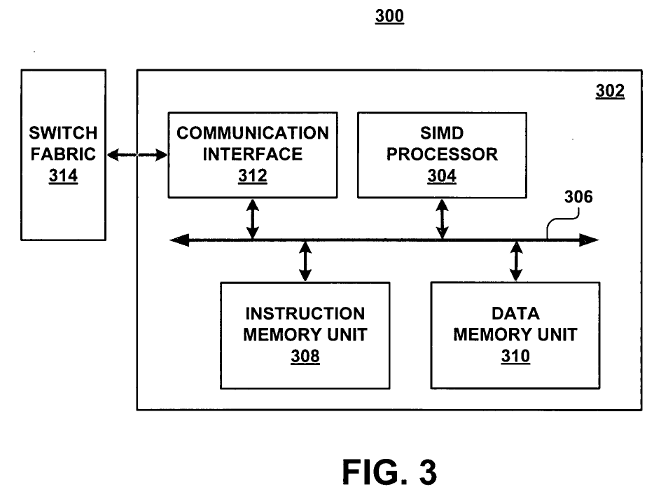

FIG. 3 illustrates one embodiment of system. FIG. 3 illustrates a block diagram of a Single Instruction Multiple Data (SIMD) processing system 300. In various implementations, the SIMD processing system 300 may be arranged to perform various media processing operations including multi-threaded parallel execution of media encoding operations, such as VLC operations. In various embodiments, the media processing node 100 may perform multi-threaded parallel execution of media encoding by implementing SIMD processing. It is to be understood that the illustrated SIMD processing system 300 is an exemplary embodiment and may include additional components, which have been omitted for clarity and ease of understanding.

The media processing system 300 may comprise a media processing apparatus 302. In various embodiments, the media processing apparatus 302 may comprise a SIMD processor 304 having access to various functional units and resources. The SIMD processor 304 may comprise, for example, a general purpose processor, a dedicated processor, a DSP, media processor, a graphics processor, a communications processor, and so forth. The embodiments are not limited in this context.

In various embodiments, the SIMD processor 304 may comprise, for example, a number of processing engines such micro-engines or cores. Each of the processing engines may be arranged to execute programming logic such as micro-blocks running on a thread of a micro-engine for multiple threads of execution (e.g., four, eight). The embodiments are not limited in this context.

In various embodiments, the SIMD processor 304 may comprise, for example, a SIMD execution engine such as an n-operand SIMD execution engine to concurrently execute a SIMD instruction for n-operands of data in a single instruction period. For example, an eight-channel SIMD execution engine may concurrently execute a SIMD instruction for eight 32-bit operands of data. Each operand may be mapped to a separate compute channel of the SIMD execution engine. In various implementations, the SIMD execution engine may receive a SIMD instruction along with an n-component data vector for processing on corresponding channels of the SIMD execution engine. The SIMD engine may concurrently execute the SIMD instruction for all of the components in the vector. The embodiments are not limited in this context.

In various implementations, a SIMD instruction may be conditional. For example, a SIMD instruction or set of SIMD instructions might be executed upon satisfactions of one or more predetermined conditions. In various embodiments, parallel loop over of certain processing operations may be enabled using a SIMD conditional branch and loop mechanism. The conditions may be based on one or more macroblocks and/or blocks. The embodiments are not limited in this context.

In various embodiments, the SIMD processor 304 may implement region-based register access. The SIMD processor 304 may comprise, for example, a register file and an index file to store a value describing a region in the register file to store information. In some cases, the region may be dynamic. The indexed register may comprise multiple independent indices. In various implementations, a value in the index register may define one or more origins of a region in the register file. The value may represent, for example, a register identifier and/or a sub-register identifier indicating a location of a data element within a register. A description of a register region (e.g., register number, sub-register number) may be encoded in an instruction word for each operand. The index register may include other values to describe the register region such as width, horizontal stride, or data type of a register region. The embodiments are not limited in this context.

In various embodiments, the SIMD processor 304 may comprise a flag structure. The SIMD processor 304 may comprise, for example, one or more flag registers for storing flag words or flags. A flag word may be associated with one or more results generated by a processing operation. The result may be associated with, for example, a zero, a not zero, an equal to, a not equal to, a greater than, a greater than or equal to, a less than, a less than or equal to, and/or an overflow condition. The structure of the flag registers and/or flag words may be flexible. The embodiments are not limited in this context.

In various embodiments, a flag register may comprise an n-bit flag register of an n-channel SIMD execution engine. Each bit of a flag register may be associated with a channel, and the flag register may receive and store information from a SIMD execution unit. In various implementations, the SIMD processor 304 may comprise horizontal and/or vertical evaluation units for one or more flag registers. The embodiments are not limited in this context.

The SIMD processor 304 may be coupled to one or more functional units by a bus 306. In various implementations, the bus 306 may comprise a collection of one or more on-chip buses that interconnect the various functional units of the media processing apparatus 302. Although the bus 306 is depicted as a single bus for ease of understanding, it may be appreciated that the bus 306 may comprise any bus architecture and may include any number and combination of buses. The embodiments are not limited in this context.

The SIMD processor 304 may be coupled to an instruction memory unit 308 and a data memory unit 310. In various embodiments, the instruction memory 308 may be arranged to store SIMD instructions, and the data memory unit 310 may be arranged to store data such as scalars and vectors associated with a two-dimensional image, a three-dimensional image, and/or a moving image. In various implementations, the instruction memory unit 308 and/or the data memory unit 310 may be associated with separate instruction and data caches, a shared instruction and data cache, separate instruction and data caches backed by a common shared cache, or any other cache hierarchy. The embodiments are not limited in this context.

The instruction memory unit 308 and the data memory unit 310 may comprise, or be implemented as, any computer-readable storage media capable of storing data, including both volatile and non-volatile memory. Examples of storage media include random-access memory (RAM), dynamic RAM (DRAM), Double-Data-Rate DRAM (DDRAM), synchronous DRAM (SDRAM), flash memory, ROM, programmable ROM (PROM), erasable programmable ROM (EPROM), electrically erasable programmable ROM (EEPROM), flash memory, content addressable memory (CAM), polymer memory (e.g., ferroelectric polymer memory, ovonic memory, phase change or ferroelectric memory), silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information. The storage media may contain various combinations of machine-readable storage devices and/or various controllers to store computer program instructions and data. The embodiments are not limited in this context.

The media processing apparatus 302 may comprise a communication interface 312. The communication interface 312 may comprises any suitable hardware, software, or combination of hardware and software that is capable of coupling the media processing apparatus 302 to one or more networks and/or network devices. In various embodiments, the communication interface 312 may comprise one or more interfaces such as, for example, a transmit interface, a receive interface, a Media and Switch Fabric (MSF) Interface, a System Packet Interface (SPI), a Common Switch Interface (CSI), a Peripheral Component Interface (PCI), a Small Computer System Interface (SCSI), an Internet Exchange (IE) interface, a Fabric Interface Chip (FIC), a line card, a port, or any other suitable interface. The embodiments are not limited in this context.

In various implementations, the communication interface 312 may be arranged to connect the media processing apparatus 302 to one or more physical layer devices and/or a switch fabric 314. The media processing apparatus 302 may provide an interface between a network and the switch fabric 314. The media processing apparatus 302 may perform various media processing on data for transmission across the switch fabric 314. The embodiments are not limited in this context.

In various embodiments, the SIMD processing system 300 may achieve data-level parallelism by employing SIMD instruction capabilities and flexible access to one more indexed registers, region-based registers, and/or flag registers. In various implementations, for example, the SIMD processor system 300 may receive multiple blocks and/or macroblocks of data and perform block-level and macroblock-level processing in SIMD fashion. The results of processing operations (e.g., comparison operations) may be packed into flag words using flexible flag structures. SIMD operations may be performed in parallel on flag words for different blocks that are packed into SIMD registers. For example, the number of preceding zero-value coefficients of a nonzero-value coefficient may be determined using instructions such as leading-zero-detection (LZD) operations on the flag words. Flag words for multiple blocks may be packed into SIMD registers using region-based register access capability. Parallel moving of the nonzero-value coefficient values for multiple blocks may be performed in parallel using multi-index SIMD move instruction and region-based register access for multiple sources and/or multiple destination indices. Parallel memory accesses, such as table (e.g., Huffman table) look ups, may be performed using data port scatter-gathering capability. The embodiments are not limited in this context.

Operations for various embodiments may be further described with reference to the following figures and accompanying examples. Some of the figures may include a logic flow. It can be appreciated that the logic flow merely provides one example of how the described functionality may be implemented. Further, the given logic flow does not necessarily have to be executed in the order presented unless otherwise indicated. In addition, the logic flow may be implemented by a hardware element, a software element executed by a processor, or any combination thereof. The embodiments are not limited in this context.

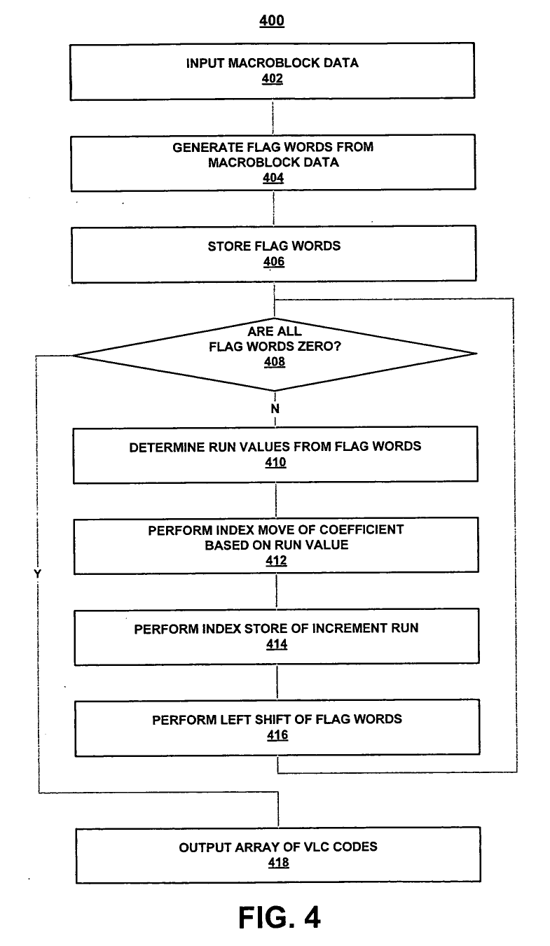

FIG. 4 illustrates one embodiment of a logic flow 400. FIG. 4 illustrates logic flow 400 for performing media processing. In various embodiments, the logic flow 400 may be performed by a media processing node such as media processing node 100 and/or an encoding module such as entropy encoding module 120. The logic flow 400 may comprise SIMD-based encoding of a macroblock. The SIMD-based encoding may comprise, for example, entropy coding such as VLC (e.g., run-level VLC), CAVLC, CABAC, and so forth. In various implementations, entropy encoding may involve representing a sequence of scanned coefficients (e.g., transformed quantized scanned coefficients) as a sequence of run-level symbols. Each run-level symbol may comprise a run-level pair, where level is the value of a nonzero-value coefficient, and run is the number of zero-value coefficients preceding the nonzero-value coefficient. The embodiments are not limited in this context.

The logic flow 400 may comprise inputting macroblock data (402). In various embodiments, a macroblock may comprise N blocks (e.g., 6 blocks for YUV420, 12 blocks for YUC444, etc.), and the macroblock data may comprise a sequence of scanned coefficients (e.g., DCT transformed quantized scanned coefficients) for each block of the macroblock. For example, a macroblock may comprise six blocks of data, and each block may comprise an 8×8 matrix of coefficients. In this case, the macroblock data may comprise a sequence of 64 coefficients for each block of the macroblock. In various implementations, the macroblock data may be processed in parallel in SIMD fashion. The embodiments are not limited in this context.

The logic flow 400 may comprise generating flag words from the macroblock data (404). In various embodiments, a comparison against zero may be performed on the macroblock data, and flag words may be generated based on the results of the comparisons. For example, a comparison against zero may be performed on the sequence of scanned coefficients for each block of a macroblock. Each flag word may comprise one-bit per coefficient based on the comparison results. For example, a 64-bit flag word comprising ones and zeros based on the comparison results may be generated from the 64 coefficients of an 8×8 block. In various implementations, multiple flag words may be generated in parallel in SIMD fashion by packing comparison results for multiple blocks into SIMD flexible flag registers. The embodiments are not limited in this context.

The logic flow 400 may comprise storing flag words (406). In various embodiments, flag words for multiple blocks may be stored in parallel. For example, six 64-bit flag words corresponding to six blocks of a macroblock may be stored in parallel. In various implementations, flag words for multiple blocks may be stored in parallel in SIMD fashion by packing the flag words into SIMD registers having region-based register access capability. The embodiments are not limited in this context.

The logic flow 400 may comprise determining whether all flag words are zero (408). In various embodiments, a comparison may be made for each flag word to determine whether the flag word contains only zero-value coefficients. When the flag word contains zero-value, it may be determined that the end of block (EOB) is reached for the block. In various implementations, multiple determinations may be performed in parallel for multiple flag words. For example, determinations may be performed in parallel for six 64-bit flag words. The embodiments are not limited in this context.

The logic flow 400 may comprise determining run values from the flag words (410) in the event that all flag words are not zero. In various embodiments, leading-zero detection (LZD) operations may be performed on the flag words. LZD operations may be performed in SIMD fashion using SIMD instructions, for example. The result of LZD operations may comprise the number of zero-value coefficients preceding a nonzero-value coefficient in a flag word. A run value may be set based on the result of the LZD operations, for example, run=LZD(flags). The run value may correspond to the number of zero-value coefficients preceding a nonzero-value coefficient in a sequence of scanned coefficients for a block associated with the flag word. As a result, the determined run value may be used for a run-level symbol for the block associated with the flag. In various implementations, SIMD LZD operations may be performed in parallel on multiple flag words for multiple blocks that are packed into SIMD registers. For example, SIMD LZD operations may be performed in parallel for six 64-bit flag words. The embodiments are not limited in this context.

The logic flow 400 may comprise performing an index move of a coefficient based on the run value (412). In various embodiments, the index move may be performed in SIMD fashion using SIMD instructions, for example. The coefficient may comprise a nonzero-value coefficient in a sequence of scanned coefficients for a block. The run value may correspond to the number of zero-value coefficients preceding a nonzero-value coefficient in a sequence of scanned coefficients for a block. The index move may move the nonzero-value coefficient from a storage location (e.g., a register) to the output. In various embodiments, the nonzero-value coefficient may comprise a level value of a run-level symbol for a block. In various implementations, index move operations may be performed in parallel for multiple blocks. The index move may be performed, for example, using a multi-index SIMD move instruction and region-based register access for multiple sources and/or multiple destination indices. The multi-index SIMD move instruction may be executed conditionally. The condition may be determined by whether EOB is reached or not for a block. If EOB is reached for a block, the move is not performed for the block. Meanwhile, if EOB is not reached for another block, the move is performed for the block. The embodiments are not limited in this context.

The logic flow 400 may comprise performing an index store of increment run (414). In various embodiments, the index store may be performed in SIMD fashion using SIMD instructions, for example. The increment run may be used to locate the next nonzero-value coefficient in a sequence of scanned coefficients. For example, the increment run may be used when performing an index move of a nonzero-value coefficient from a sequence of scanned coefficients for a block. In various implementations, index store operations may be performed in parallel for multiple blocks. The multi-index SIMD store instruction may be executed conditionally. The condition may be determined by whether EOB is reached or not for a block. If EOB is reached for a block, the store is not performed for the block. Meanwhile, if EOB is not reached for another block, the store is performed for the block. The embodiments are not limited in this context.

The logic flow 400 may comprise performing a left shift of flag words (416). In various embodiments, a left shift may be performed on a flag word to remove a remove a nonzero-value coefficient from a flag word for a block. The left shift may be performed in SIMD fashion, using SIMD instructions, for example. In various implementations, left shift operations may be performed in parallel for multiple flag words for multiple blocks. The SIMD left shift instruction may be executed conditionally. The condition may be determined by whether EOB is reached or not for a block. If EOB is reached for a block, the left shift is not performed to the flag word for the block. Meanwhile, if EOB is not reached for another block, the left shift is performed to the flag for the block. The embodiments are not limited in this context.

The logic flow 400 may comprise performing one or more parallel loops to determine all the run-level symbols of the blocks of a macroblock. In various embodiments, the parallel loops may be performed in SIMD fashion using a SIMD loop mechanism, for example. In various implementations, a conditional branch may be performed in SIMD fashion using a SIMD conditional branch mechanism, for example. The conditional branch may be used to terminate and/or bypass a loop when processing for a block has been completed. The conditions may be based on one, some, or all blocks. For example, when a flag word associated with a particular block contains only zero-value coefficients, a conditional branch may discontinue further processing with respect to the particular block while allowing processing to continue for other blocks. The processing may include, but not limited to, determining run value, index move of the coefficient, and index store of incremental run. The embodiments are not limited in this context.

The logic flow 400 may comprise outputting an array of VLC codes (418) when all flag words are zero. In various embodiments, run-level symbols may be converted into VLC codes according to predetermined Huffman tables. In various implementations, parallel Huffman table look ups may be performed in SIMD fashion using the scatter-gathering capability of a data port, for example. The array of VLC codes may be output to a packing module, such as bitstream packing module 122, to form the code sequence for a macroblock. The embodiments are not limited in this context.

In various implementations, the described embodiments may perform parallel execution of media encoding (e.g., VLC) using SIMD processing. The described embodiments may comprise, or be implemented by, various processor architectures (e.g., multi-threaded and/or multi-core architectures) and/or various SIMD capabilities (e.g., SIMD instruction set, region-based registers, index registers with multiple independent indices, and/or flexible flag registers). The embodiments are not limited in this context.

In various implementations, the described embodiments may achieve thread-level and/or data-level parallelism for media encoding resulting in improved processing performance. For example, implementation of a multi-threaded approach may improve multi-threaded processing speeds approximately linear to the number of processing cores and/or the number of hardware threads (e.g., ˜16× speed up on a 16-core processor). Implementation of LZD detection using flag words and LZD instructions may improve processing speed (e.g., ˜4-10× speed up) over a scalar loop implementation. The parallel processing of multiple blocks (e.g., 6 blocks) using SIMD LZD operations and branch/loop mechanisms may improve processing speed (e.g., ˜6× speed up) over block-sequential algorithms. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

In various implementations, the described embodiments may comprise, or form part of a wired communication system, a wireless communication system, or a combination of both. Although certain embodiments may be illustrated using a particular communications media by way of example, it may be appreciated that the principles and techniques discussed herein may be implemented using various communication media and accompanying technology.

In various implementations, the described embodiments may comprise or form part of a network, such as a Wide Area Network (WAN), a Local Area Network (LAN), a Metropolitan Area Network (MAN), the Internet, the World Wide Web, a telephone network, a radio network, a television network, a cable network, a satellite network, a wireless personal area network (WPAN), a wireless WAN (WWAN), a wireless LAN (WLAN), a wireless MAN (WMAN), a Code Division Multiple Access (CDMA) cellular radiotelephone communication network, a third generation (3G) network such as Wide-band CDMA (WCDMA), a fourth generation (4G) network, a Time Division Multiple Access (TDMA) network, an Extended-TDMA (E-TDMA) cellular radiotelephone network, a Global System for Mobile Communications (GSM) cellular radiotelephone network, a North American Digital Cellular (NADC) cellular radiotelephone network, a universal mobile telephone system (UMTS) network, and/or any other wired or wireless communications network configured to carry data. The embodiments are not limited in this context.

In various implementations, the described embodiments may be arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth.

In various implementations, the described embodiments may be arranged to communicate information over one or more types of wireless communication media. An example of a wireless communication media may include portions of a wireless spectrum, such as the radio-frequency (RF) spectrum. In such implementations, the described embodiments may include components and interfaces suitable for communicating information signals over the designated wireless spectrum, such as one or more antennas, wireless transmitters/receivers (“transceivers”), amplifiers, filters, control logic, and so forth. As used herein, the term “transceiver” may be used in a very general sense to include a transmitter, a receiver, or a combination of both and may include various components such as antennas, amplifiers, and so forth. Examples for the antenna may include an internal antenna, an omni-directional antenna, a monopole antenna, a dipole antenna, an end fed antenna, a circularly polarized antenna, a micro-strip antenna, a diversity antenna, a dual antenna, an antenna array, and so forth. The embodiments are not limited in this context.

In various embodiments, communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth. The embodiments are not limited in this context.

In various implementations, the described embodiments may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks. The embodiments are not limited in this context.

In some implementations, information may be communicated according to one or more IEEE 802 standards including IEEE 802.11×(e.g., 802.11a, b, g/h, j, n) standards for WLANs and/or 802.16 standards for WMANs. Information may be communicated according to one or more of the Digital Video Broadcasting Terrestrial (DVB-T) broadcasting standard, and the High performance radio Local Area Network (HiperLAN) standard. The embodiments are not limited in this context.

In various implementations, the described embodiments may comprise or form part of a packet network for communicating information in accordance with one or more packet protocols as defined by one or more IEEE 802 standards, for example. In various embodiments, packets may be communicated using the Asynchronous Transfer Mode (ATM) protocol, the Physical Layer Convergence Protocol (PLCP), Frame Relay, Systems Network Architecture (SNA), and so forth. In some implementations, packets may be communicated using a medium access control protocol such as Carrier-Sense Multiple Access with Collision Detection (CSMA/CD), as defined by one or more IEEE 802 Ethernet standards. In some implementations, packets may be communicated in accordance with Internet protocols, such as the Transport Control Protocol (TCP) and Internet Protocol (IP), TCP/IP, X.25, Hypertext Transfer Protocol (HTTP), User Datagram Protocol (UDP), and so forth. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk ROM (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an ASIC, PLD, DSP, and so forth. In yet another example, an embodiment may be implemented by any combination of programmed general-purpose computer components and custom hardware components. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to thosed skilled in the art. It is therefore to be understood that the appended claims are intended to cover all such modifications and changes as fall within the true spirit of the embodiments.

1. An apparatus, comprising:
a media processing node to perform single instruction multiple data processing of macroblock data, said macroblock data comprising coefficients for multiple blocks of a macroblock, said media processing node comprising:
an encoding module to generate multiple flag words associated with said multiple blocks from said macroblock data and to determine run values for multiple blocks in parallel from said flag words.

2. The apparatus of claim 1, wherein said coefficients comprise a sequence of transformed quantized scanned coefficients for each of said multiple blocks.

3. The apparatus of claim 1, wherein said encoding module is to store flag words in a flag register.

4. The apparatus of claim 1, wherein said encoding module is to determine run values by performing leading-zero detection.

5. The apparatus of claim 1, wherein said encoding module is to perform parallel moving of nonzero-value coefficients for multiple blocks based on said run values.

6. The apparatus of claim 5, wherein said nonzero-value coefficients correspond to level values for multiple blocks.

7. The apparatus of claim 1, wherein said encoding module is to output an array of codes to a packing module to form a code sequence for said macroblock.

8. The apparatus of claim 7, wherein:
said packing module is partitioned from said encoding module, and
said encoding module is to perform multi-threaded processing of multiple macroblocks.

9. A system, comprising:
a communications medium;
a single instruction multiple data processing apparatus to couple to said communications medium, said single instruction multiple data processing apparatus comprising:
a media processing node to process macroblock data, said macroblock data comprising coefficients for multiple blocks of a macroblock, said media processing node comprising an encoding module to generate multiple flag words associated with said multiple blocks from said macroblock data and to determine run values for multiple blocks in parallel from said flag words.

10. The system of claim 9, wherein said coefficients comprise a sequence of transformed quantized scanned coefficients for each of said multiple blocks.

11. The system of claim 9, wherein said encoding module is to store flag words in a flag register.

12. The system of claim 9, wherein said encoding module is to determine run values by performing leading-zero detection.

13. The system of claim 9, wherein said encoding module is to perform parallel moving of nonzero-value coefficients for multiple blocks based on said run values.

14. The system of claim 13, wherein said nonzero-value coefficients correspond to level values for multiple blocks.

15. The system of claim 9, wherein said encoding module is to output an array of codes to a packing module to form a code sequence for said macroblock.

16. The system of claim 15, wherein:
said packing module is partitioned from said encoding module, and
said encoding module is to perform multi-threaded processing of multiple macroblocks.

17. A method, comprising:
receiving macroblock data comprising coefficients for multiple blocks of a macroblock; and
performing single instruction multiple data processing of said macroblock data comprising generating multiple flag words associated with said multiple blocks from said macroblock data and determining run values for multiple blocks in parallel from said flag words.

18. The method of claim 17, wherein said coefficients comprise a sequence of transformed quantized scanned coefficients for each of said multiple blocks.

19. The method of claim 17, further comprising storing flag words in a flag register.

20. The method of claim 17, further comprising determining run values by performing leading-zero detection.

21. The method of claim 17, further comprising performing parallel moving of nonzero-value coefficients for multiple blocks based on said run values.

22. The method of claim 21, further comprising determining level values for multiple blocks based on said nonzero-value coefficients.

23. The method of claim 17, further comprising outputting an array of codes to form a code sequence for said macroblock.

24. The method of claim 23, further comprising performing multi-threaded processing of multiple macroblocks.

25. An article comprising a machine-readable storage medium containing instructions that if executed enable a system to:
receive macroblock data comprising coefficients for multiple blocks of a macroblock; and
perform single instruction multiple data processing of said macroblock data comprising generating multiple flag words associated with said multiple blocks from said macroblock data and determining run values for multiple blocks in parallel from said flag words.

26. The article of claim 25, wherein said coefficients comprise a sequence of transformed quantized scanned coefficients for each of said multiple blocks.

27. The article of claim 25, further comprising instructions that if executed enable the system to store flag words in a flag register.

28. The article of claim 25, further comprising instructions that if executed enable the system to determine run values by performing leading-zero detection.

29. The article of claim 25, further comprising instructions that if executed enable the system to perform parallel moving of nonzero-value coefficients for multiple blocks based on said run values.

30. The article of claim 29, further comprising instructions that if executed enable the system to determine level values for multiple blocks based on said nonzero-value coefficients.

31. The article of claim 25, further comprising instructions that if executed enable the system to output an array of codes to form a code sequence for said macroblock.

32. The article of claim 25, further comprising instructions that if executed enable the system to perform multi-threaded processing of multiple macroblocks.

33. A method comprising:
receiving macroblock data; and
performing parallel multi-threaded processing of said macroblock data comprising concurrent motion estimation operations, encoding operations, and reconstruction operations, wherein said encoding operations are function- and data-domain partitioned from said reconstruction operations to achieve thread-level parallelism.

34. The method of claim 33, wherein multi-threaded processing comprises variable length encoding operations.

35. The method of claim 33, wherein multi-threaded processing comprises bitstream packing operations.
